(19) United States
(12) Patent Application Publication
(10) Pub. No.: US 2007/0193866 A1
(43) Pub. Date: Aug. 23, 2007

(54) LAMPHOLDER

(76) Inventors: John Eder, Floral Park, NY (US); Scot J. Hale, Williston Park, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/624,020

(22) Filed: Jan. 17, 2007

Related U.S. Application Data
(60) Provisional application No. 60/759,910, filed on Jan. 18, 2006.

(51) Int. Cl. H01H 9/00

(52) U.S. Cl. 200/310

(57) ABSTRACT

A lamp holder is disclosed having a visual indicator that allows a user to locate the pull chain of the lamp holder in a dark environment. In an embodiment, the lamp holder is an outlet box lamp holder which can be mounted onto an outlet box located in a dark environment. The lamp holder has a socket to support a light bulb and a pull-chain switch actuator to control power to the lamp socket. The visual indicator can be a neon lamp disposed on the lamp holder and adjacent the pull-chain actuator.

This application claims priority pursuant to 35 U.S.C. 119(e) from U.S. Provisional Application having Application No. 60/759,910 filed Jan. 18, 2006.

### BACKGROUND OF THE INVENTION

1. Field Of the Invention

The present invention is directed to a lamp holder.

2. Description of the Prior Art

Lamp holders are electrical wiring devices having a lamp socket to receive a light bulb and a switch to turn ON or OFF the light bulb. An example of a lamp holder is an outlet box lamp holder configured to be mounted to an outlet box in a ceiling or wall of a building structure. The outlet box lamp holder also may include a pull chain coupled to an internal switching mechanism which is used to turn ON or OFF the light bulb when a user pulls on the pull chain. Often such a lamp holder is installed in a dark environment or location such as a basement, closet or attic which may make it difficult for a user to locate the lamp holder when the light bulb is OFF. What is needed is a means of indicating the location of a lamp holder in a dark environment.

### SUMMARY OF THE INVENTION

The invention is directed to an improved lamp holder having a visual indicator that allows a user to locate the pull chain of a lamp holder in a dark environment. In one embodiment, the lamp holder is an outlet box lamp holder which can be mounted onto an outlet box located on a ceiling of a basement or other dark environment. The lamp holder has a lamp socket to support a light bulb and a pull chain switch actuator to control power to the lamp socket. The visual indicator can be a neon lamp or other lighting element disposed on the lamp holder and adjacent the pull chain actuator. The visual indicator can be configured to always be ON (illuminated) or to turn ON only when the light source is turned OFF. In each case, the visual indicator helps a user locate the actuator in a dark environment.

Other features of the invention will be pointed out in the following description and claims and illustrated in the accompanying drawings, which disclose, by way of example, the principle of the invention and the best mode which is presently contemplated by carrying them out.

### BRIEF DESCRIPTION OF THE DRAWINGS

In the drawings in which similar elements are given similar reference characters:

FIG. 1 is a perspective view of a lamp holder in accordance with an embodiment of the invention;

FIG. 2 is a bottom view of the lamp holder of FIG. 1;

FIG. 3 is a side view of the lamp holder of FIG. 1;

FIG. 4 is a schematic diagram of the electrical circuit a lamp holder in accordance with an embodiment of the present invention; and

FIG. 5 is a schematic diagram of the electrical circuit a lamp holder in accordance with another embodiment of the present invention.

### DETAILED DESCRIPTION OF THE INVENTION

The invention is directed to an improved lamp holder having a visual indicator that allows a user to locate the pull chain of a lamp holder in a dark environment. In one embodiment, the lamp holder is an outlet box lamp holder which can be mounted onto an outlet box located on a ceiling of a basement or other dark environment. The lamp holder has a lamp socket to support a light bulb and a pull chain switch actuator to control power to the lamp socket. The visual indicator can be a neon lamp or other lighting element, disposed on the lamp holder and adjacent the pull chain actuator. The visual indicator is turned On (illuminated) when the light bulb is OFF thus providing a user a means of locating the pull chain actuator in a dark environment. The visual indicator can be configured to always be ON (illuminated) or to turn ON only when the light source is turned OFF. In each case, the visual indicator helps a user locate the actuator in a dark environment.

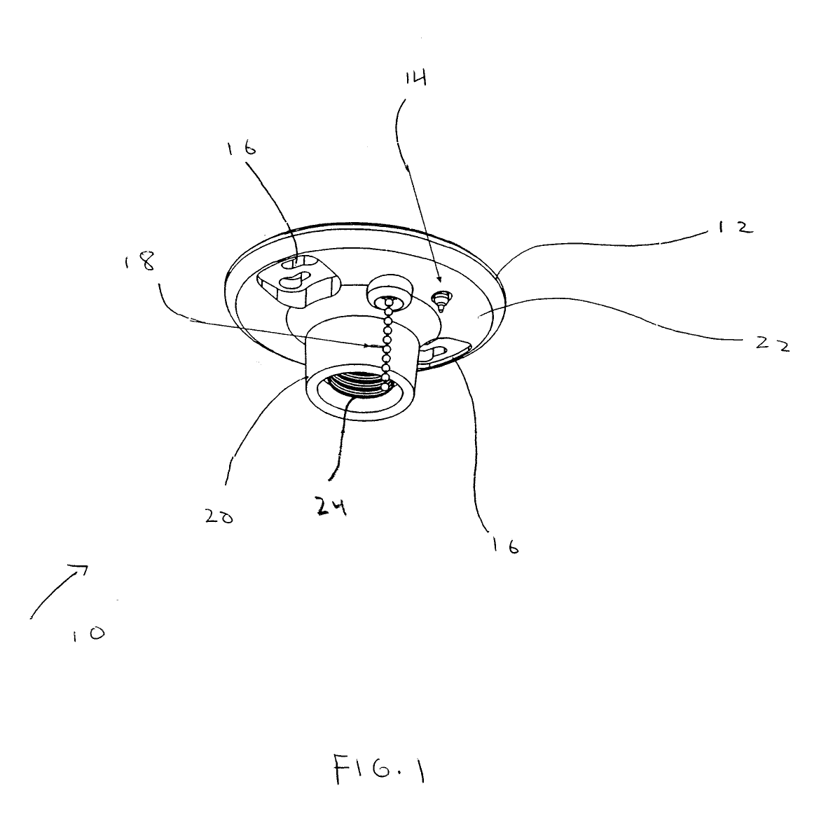

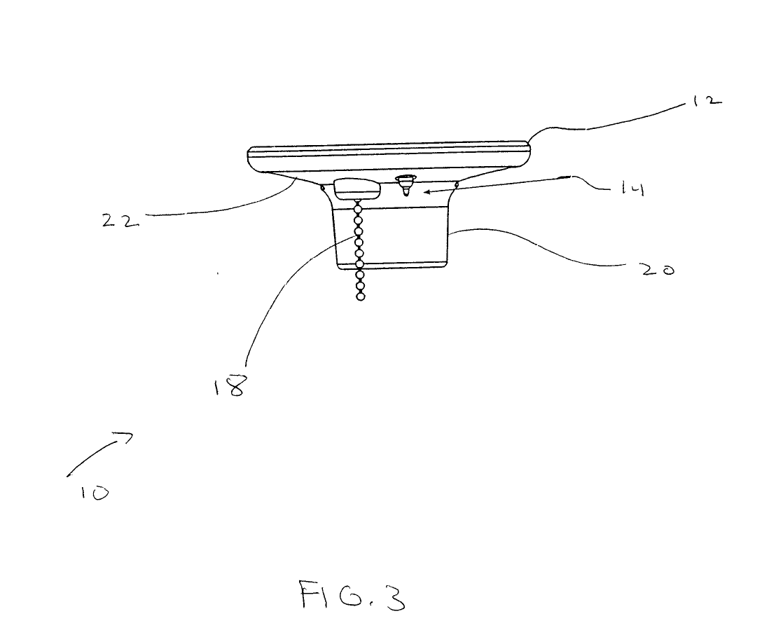

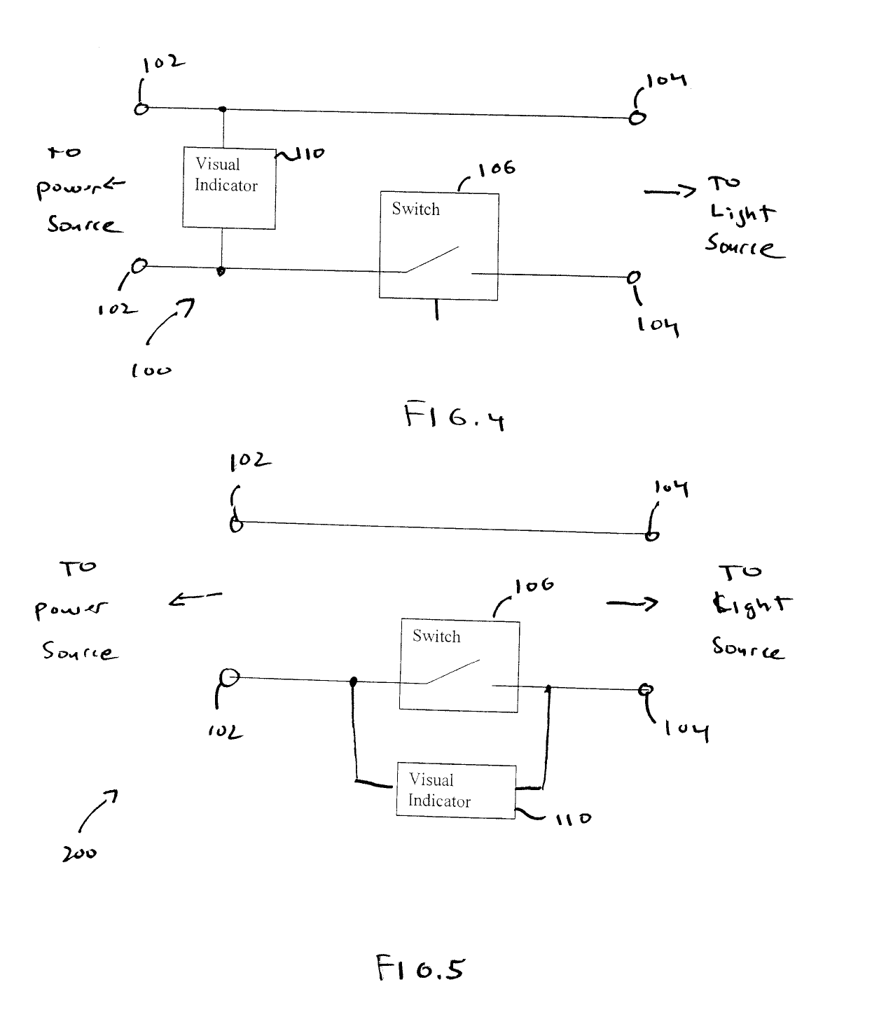

Referring to FIGS. 1-3, shown is an outlet box mountable lamp holder 10 having a lamp body 22 supporting a switch actuator 18, such as a pull chain, adjacent a visual indicator 14 that allows a user to locate the actuator in a dark environment. In this embodiment, the lamp holder 10 includes a lamp socket 20 centrally located on the front surface of the lamp body 22 to support a light source such as a light bulb (not shown). Power is delivered to the lamp socket 20 via electrical wires (not shown) which can extend from the rear surface of the lamp body 22. The electrical wires can be connected to power conductors (phase and neutral) of a power source (not shown) such as a 120 VAC, 60 Hz standard household electrical wiring system. In one embodiment, the switch actuator 18 is a pull chain actuator that extends through an opening on the flange portion of the front surface of the lamp body 22. The switch actuator 18 allows a user to activate a switch mechanism (not shown) to control power to the lamp socket. The visual indicator 14 extends through the front flange portion of the lamp body 22 and is located adjacent the switch actuator 18. The visual indicator 14 can be configured to always be ON (illuminated) (see FIG. 4) or to turn ON only when the light source is turned OFF (see FIG. 5). In each case, the visual indicator helps a user locate the actuator 18 in a dark environment.

Mounting openings 16 extending through the front and rear surfaces of the lamp body 22 allow the lamp holder to be mounted to an outlet box or other support means via mounting screws (not shown). The lamp socket 20 is shown as an insulated cylindrical tube with a threaded electrically conducting interior member 24 to support an incandescent light bulb (not shown), but other forms of lamp sockets can be employed for other light sources such as florescent lamps. The lamp body is made of insulative material such as porcelain, plastic or the like.

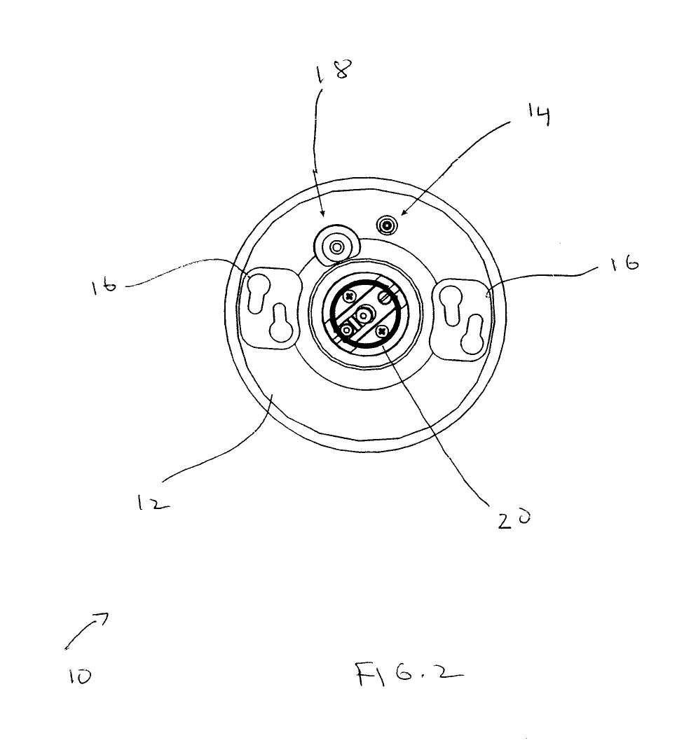

FIG. 4 is a schematic diagram of the electrical circuit of a lamp holder 100 in accordance with an embodiment of the present invention. The circuit of the lamp holder 100 includes input (line side) conductors 102 for connection to a power source (not shown) and output (load side) conductors 104 for connection to a light source (not shown). In one embodiment, the input conductors 102 can be electrical wires extending from the rear portion of the lamp holder 10 of FIG. 2 and the output conductors 104 can be conductors disposed in the interior member 24 of the lamp socket 20 of FIG. 1. A switch mechanism 106 is shown connected in series between the input conductors 102 and the output conductors 104. The switch mechanism 106 can be a single throw switch capable of being switched between a CLOSED and an OPEN position. In the CLOSED position, a conductive path is made between the power source and the visual indicator and the light source. In the OPEN position (shown in FIG. 4), the conductive path to the light source is broken but the visual indicator remains powered. The switch mechanism 106 can be mechanical, electromechanical, solid-state or any other means of switching power to the lamp source. In addition, other types of switches can be used, such as a two circuit switch for HI-LO-OFF operation, for example.

An actuator (not shown) can be coupled to the switch mechanism 106 to activate the switch mechanism between its CLOSED and OPEN positions. The actuator can include a manual means of actuating the switch mechanism such as the pull chain 14 of FIG. 2, a user activated button, or other means. A visual indicator 110 is electrically connected in parallel across the input conductors 102. In a preferred embodiment, the visual indicator 110 is a low wattage device compared to the light source so that the visual indicator consumes less power than the light source. The visual indicator 110 can be a low wattage light means such as a light emitting diode (LED), neon lamp, low wattage incandescent light bulb, or other forms of visual indicators.

In operation, it is assumed that a power source is connected across the input conductors 102 and a light source is connected across the output conductors 104. Initially, the switch mechanism 106 is switched to the OPEN position by a user engaging the switch actuator. As a result, the conductive path between the light source and the power source is broken thus disconnecting the power source from the light source and turning the light source OFF (no longer illuminating). The visual indicator 110 is connected across the input conductors 104, so it is always turned ON and thus continually illuminating the location of the actuator. The visual indicator is preferably a low wattage device compared to the light source, so the visual indicator consumes little power.

At some later time, a user can locate the lamp holder and/or actuator because the visual indicator is turned ON thereby illuminating the actuator. The user engages the actuator to cause the switch mechanism 106 to switch to the CLOSED position. As a result, the conductive path between the power source and the light source is made thereby turning the light source ON (illuminated). The visual indicator 110 remains turned ON because it is connected across the input connectors 102.

FIG. 5 is a schematic diagram of the electrical circuit of a lamp holder 200 with the visual indicator 110 connected across the switch mechanism 106 instead of across the input conductors 102 as in FIG. 4. In operation, it is assumed that a power source is connected across the input conductors 102 and a light source is connected across the output conductors 104. Initially, the switch mechanism 106 is switched to the OPEN position by a user engaging the actuator. As a result, the conductive path between the power source and the light source is broken thus disconnecting the power source from the light source and turning the light source OFF (not illuminating). The visual indicator 110 is connected across the switch mechanism 106 so the visual indicator will be ON only when the switch mechanism is in the OPEN position. Because the visual indicator 110 is preferably a low wattage (high impedance) device, the current flow is not sufficient to turn the light source ON. In this configuration, the visual indicator 110 only turns ON when the light source is turned OFF.

When the user decides to turn the light source ON, the illuminated visual indicator helps the user locate the actuator. The user engages the actuator which causes the switch mechanism 106 to switch to the CLOSED position thereby allowing current to flow to the light source. In the CLOSED position, the potential across the switch mechanism 106 is substantially zero volts and cause it to turn the visual indicator OFF. In this configuration, the visual indicator 110 turns OFF when the light source is turned ON thereby consuming less power than the configuration of FIG. 4.

As will be apparent to those skilled in the art and familiarized with the instant disclosure variations of structural details may be effected without departing from the spirit of the invention. Accordingly, the invention is to be broadly construed within the scope of the appended claims.

1. A lamp holder comprising:
a lamp body having a lamp socket to support a light source;
a switch mechanism configured to control power to the lamp socket;
a switch actuator coupled to the switch mechanism to provide a means of activating the switch mechanism; and
a visual indicator to illuminate the switch actuator.

2. The lamp holder according to claim 1 wherein said visual indicator is a neon lamp.

3. The lamp holder according to claim 1 wherein said visual indicator is a light-emitting diode.

4. The lamp holder according to claim 1 wherein said visual indicator is illuminated at all times.

5. The lamp holder according to claim 1 wherein said visual indicator provides illumination only when said light source is not illuminated.
